(19) United States
(12) Patent Application Publication
(10) Pub. No.: US 2017/0270613 A1
(43) Pub. Date: Sep. 21, 2017

(54) AGENT DISPATCH SYSTEM

(71) Applicant: Technology Enhanced Claims Handling, Inc., Palm Beach Gardens, FL (US)

(72) Inventors: Jeffrey B. Scott, Jupiter, FL (US); Andrew S. Fox, New York, NY (US)

(21) Appl. No.: 15/285,069

(22) Filed: Oct. 4, 2016

Related U.S. Application Data
(60) Provisional application No. 62/308,342, filed on Mar. 15, 2016.

(51) Int. Cl. G06Q 40/08; G06Q 10/06

(52) U.S. Cl. CPC G06Q 40/08; G06Q 10/06398; G06Q 10/063112

(57) ABSTRACT

A system, method and program product for dispatching agents. A system is provided that includes: a data processing engine for inputting a claim and creating an opportunity; an agent system interface that provides a communication link and maintains information for a network of agents; a matching system that identifies a set of agents from the network of agents to handle an aspect of the claim; a selection system that broadcasts the opportunity to the set of agents, analyzes responses from the set of agents, and assigns the claim to a selected agent; and a tracking system that monitors performance of the selected agent, and collects feedback regarding the selected agent.

### PRIORITY

The present application claims priority to co-pending U.S. Provisional Application 62/308,342 filed on Mar. 15, 2016 entitled ADJUSTER AGENT DISPATCH SYSTEM, the contents of which is hereby incorporated by reference.

### TECHNICAL FIELD

The subject matter of this invention relates to agent dispatch systems, and more particularly to a system and method of utilizing data from disparate data sources to calculate and dispatch agents in response to inputted loss information.

### BACKGROUND

As connectivity continues to play an increasing role in everyday belongings, such as with the Internet of Things, the ability to efficiently manage and deal with life-cycle issues, such as failures and loss will become a greater and greater challenge. This is particularly the case with property whose loss is covered by insurance.

When an insured entity is faced with an emergency situation involving property damage or loss, the cost to the insurance company is subject to many factors and can vary even among similar types of losses. Two third party entities that play a key role and impact the result include emergency service providers (ESP) and insurance adjusters. In some cases, the emergency service provider is contacted first directly by the insured entity, e.g., to address water damage caused by a storm, and in other cases the insurance company is contacted first who assists in finding and dispatching a qualified service provider.

Regardless, the ability for the insurance company to address the loss quickly can greatly reduce the ultimate cost to the insurance company and insured. For instance, when an insurance claim is submitted to an insurance company for a potential loss, the amount of time it takes an adjuster agent to be dispatched to the site to assess the loss directly correlates with the cost of the claim to the insurance company. The same is also the case for emergency service providers that deal with catastrophic perils such as floods, hurricanes, tornadoes, wind, fires, failures, automobile accidents, etc. In typical cases, the quicker a qualified service responder can arrive at the property to address the emergency, the lower the cost of the loss to the insurance company. For example, if a property is damaged with water intrusion, the faster a water rescue company can arrive at the property to address the issue, the lower the damage.

This correlation is not only applicable for cases involving real property or personal property, but also virtual property, property associated with the Internet of Things (IoT), etc., as well as casualty and liability losses.

Under current insurance models, adjusters and emergency service providers are often chosen in an inefficient ad hoc manner. Insurance companies often oversee and decide which adjuster is assigned to a loss based on their available adjusters and criteria. Emergency service providers are often selected by the insured based on a referral from a plumber or other third party. As part of the process, significant referral fees are often paid and pre-arranged agreements are adhered to. This unfortunately leads to inefficiencies as the selected adjuster or emergency service provider may not be the most suitable, e.g., based on time, skill, proximity, experience, cost, etc.

### SUMMARY

Aspects of the disclosure describe a platform for dispatching claims related entities (referred to herein as agents), including ESP and adjuster agents to address loss situations involving insured property. ESP agents and adjuster agents may comprise computerized software agents, entities in a virtual world, humans, or any other form of agent. Using this platform, loss information can be collected in an insurance agnostic manner to quickly generate an opportunity, identify a set of agents who can handle the opportunity, broadcast the opportunity matching agents, and oversee the agent that accepts the opportunity.

Within the platform, when a claimant (i.e., policy holder or their representative) reports loss information (e.g., by requesting an ESP or submitting a claim to a respective insurance entity), the insurance entity or insured engages the dispatch service, which in turn calculates and broadcasts an opportunity to a network of agents, such as emergency service provider agents and adjuster agents. The opportunity contains loss information that is sent to a set of qualified agents in the network, and the agents vie for the opportunity. The set of qualified agents may be calculated based on a selection algorithm that processes data from a set of disparate data sources and considers, e.g., proximity, skill set, experience, timeliness, cost, ratings, etc. Once an agent accepts the opportunity, the respective agent is immediately dispatched to the insured's property to handle the loss.

In addition to adjuster agents and ESP agents, the platform can also be used to dispatch other insurance claims related agents, such as inspector agents, drone operators, investigator agents, toxic clean-up agents, etc.

A first aspect discloses an agent dispatch system, comprising: a data processing engine that inputs loss information, interfaces with third party data sources to obtain policy details and creates at least one of an adjuster assignment opportunity and an emergency service provider (ESP) claims assignment opportunity; an agent system interface that provides a communication link and maintains information for a network of agents; a matching system that identifies a set of matching agents from the network of agents; a selection system that broadcasts an opportunity comprising at least one of the adjuster assignment opportunity and ESP claims assignment opportunity to the set of matching agents, processes responses from the set of matching agents, and assigns the opportunity to a selected agent; and an agent performance system that tracks and monitors performance of the selected agent, and collects feedback regarding the selected agent.

A second aspect discloses a computer program product stored on a computer readable storage medium, which when executed by a computing system, provides agent dispatching, comprising: program code for receiving loss information and creating an opportunity including at least one of an adjuster assignment opportunity or an emergency service provider (ESP) claims assignment opportunity; program code that provides a communication link and maintains information for a network of agents; program code that identifies a set of matching agents from the network of agents to handle the opportunity; program code that broadcasts the opportunity to the set of matching agents, analyzes responses from the set of matching agents, and assigns the opportunity to a selected agent; and program code that monitors performance of the selected agent.

A third aspect discloses a computerized method that provides insurance opportunity dispatching, comprising: inputting an electronic form that details information about a loss; interfacing with a third party data source to obtain policy details associated with the loss; creating an opportunity that includes at least one of an adjuster assignment opportunity or an emergency service provider (ESP) claims assignment opportunity; identifying a set of matching agents from a network of agents to handle the opportunity; broadcasting the opportunity to the set of matching agents, analyzing responses from the set of matching agents, and assigning the opportunity to a selected agent; and monitoring performance of the selected agent.

### BRIEF DESCRIPTION OF THE DRAWINGS

These and other features of this invention will be more readily understood from the following detailed description of the various aspects of the invention taken in conjunction with the accompanying drawings in which:

FIG. 1 shows a computing system having an agent dispatch system according to embodiments.

FIG. 2 shows a flow diagram of an adjuster agent dispatch process according to embodiments.

FIG. 3 shows a flow diagram of an ESP agent dispatch process according to embodiments.

FIG. 4 depicts a claim interface for capturing, storing and displaying a claim according to embodiments.

FIG. 5 depicts an administrative dashboard for selecting and managing agents according to embodiments.

FIG. 6 depicts a dashboard displaying a set of agents on a map interface according to embodiments.

FIG. 7 depicts a dispatch system utilized for an Internet of Things application according to embodiments.

FIG. 8 depicts an illustrative user App interface for initiating a loss process according to embodiments.

FIG. 9 depicts a further user App interface according to embodiments.

FIG. 10 depicts a further user App interface according to embodiments.

FIG. 11 depicts an agent interface according to embodiments.

FIG. 12 depicts a further agent interface according to embodiments.

FIG. 13 depicts a provider tracking interface according to embodiments.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

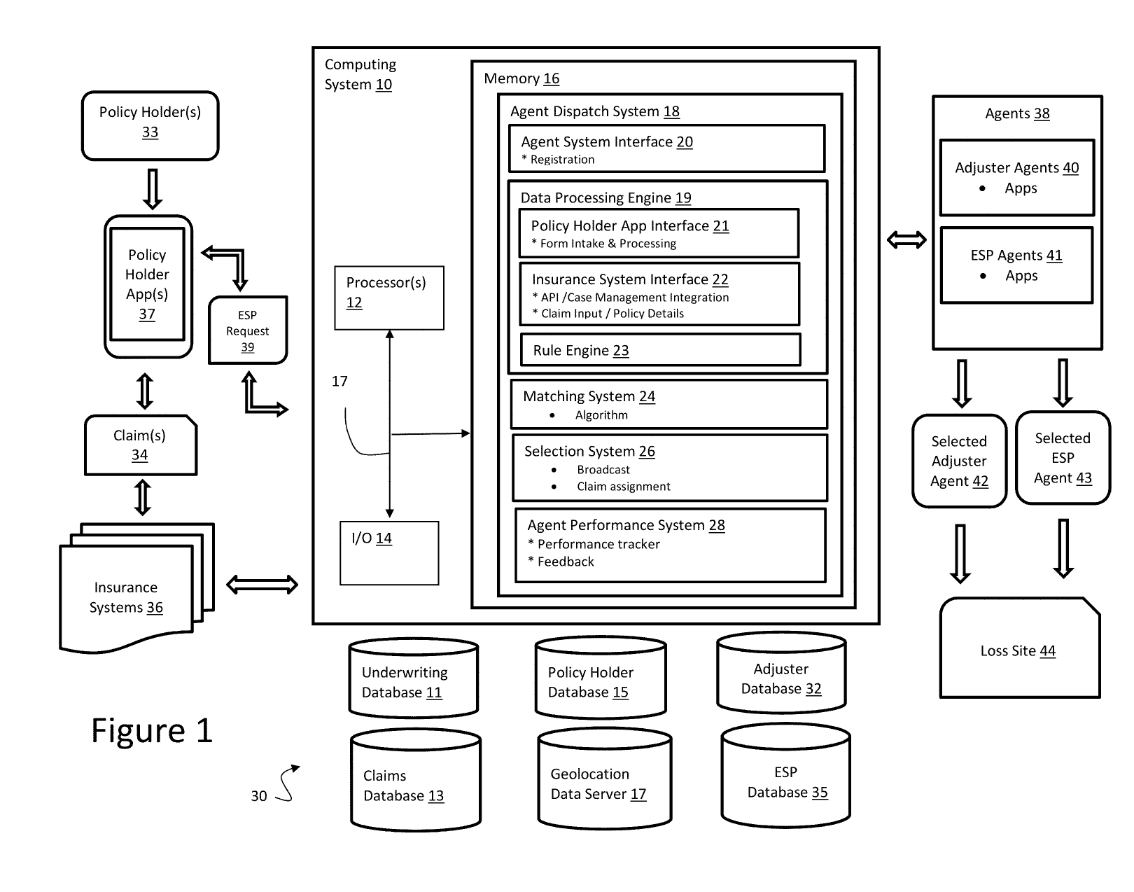

Referring now to the drawings, FIG. 1 depicts a computing system 10 having an agent dispatch system 18 that facilitates dispatch of agents 38 to a loss site 44 in response to inputted loss information, e.g., a claim 34 or emergency service provider (ESP) request 39. To provide this functionality, agent dispatch system 18 interfaces on the back end with a network of agents 38, including adjuster agents 40 and ESP agents 41 via a communication channel that may, e.g., include an App, SMS device, cell phone, etc. The network of agents 38 may include independent entities not controlled and/or employed by an insurance entity and/or agents that are employed or controlled by an insurance entity. As noted, agents 38 may comprise, e.g., computerized software agents, virtual world entities, real world human adjusters having access to a networked device, or any other form of agent. Associated agent Apps may comprise, e.g., programs adapted to run on a smart device such as a mobile phone, client software, an SMS application, special purpose hardware, firmware, Java script, bots, mobile agents, etc.

On the front end, policy holders 33 initiate the process using, e.g., a policy holder App 37 or system that allows the policy holder 33 to submit loss information, and create a claim 34 and/or ESP request 39 with their insurance entity or directly with agent dispatch system 18.

In this embodiment, different versions of policy holder App 37 may be affiliated and coupled with different insurance systems 36. Thus, policy holders 33 of different insurance entities would utilize App 37 (or other communication mechanism) specifically tailored to their respective insurance system 36. In this manner, policy details can be readily retrieved as needed from different insurance entities for policy holders 33. In one embodiment, insurance systems 36 (each associated with an insurance entity) push data to agent dispatch system 18 when a claim 34 is received by one of the insurance systems 36 based on loss information reported by a policy holder 33. In another embodiment, agent dispatch system 18 pulls data from the appropriate insurance system 36 when loss information is reported to the agent dispatch system 18. Insurance system 36 may for example include a third party claims management system and/or a claim assignment management system. Initiation of the process may also occur via telephone or other communication means.

Insurance systems 36 may comprise, e.g., traditional insurance policy and/or claims management systems that track and manage claims, automated warranty systems connected to a network of smart devices, adjuster assignment management systems, or any other type of process or system capable of managing insurance claims.

As part of the described dispatch process, agent dispatch system 18 may interface with a set of disparate data sources 30, which may include various third party legacy databases associated with insurance systems 36. Although shown stored with computing system 10, it is understood that certain data sources 30 may reside in different physical locations and be controlled by other entities (such as the Comprehensive Loss Underwriting Exchange, insurance system databases, etc.).

In this illustrative embodiment, data sources 30 utilized by agent dispatch system may include: an underwriting database 11, a claims database that tracks reported losses by policy holders, e.g., with a claim ID; a policy holder database 15 that provides, e.g., address information for the policy holder; an adjuster database 32 that details participating adjusters; an ESP database 35 that details participating ESPs; and a geolocation data server 17 that tracks the location of active agents (i.e., adjusters and ESPs).

Agent dispatch system 18 generally includes: an agent system interface 20 that provides a communication link with adjuster agents 40 and ESP agents 41; a data processing engine 19 that receives loss information, interfaces with various data sources 30 including third party legacy data sources, and creates adjuster assignment and/or ESP claims assignment opportunities; a matching system 24 that matches a submitted claim 34 or ESP request 39 with a set of (i.e., one or more) matching adjuster agents and/or ESP agents 41 from the network of agents 38; a selection system 26 that (1) broadcasts opportunities to matching adjuster agents 40 and/or ESP agents 41; (2) processes agent responses; and (3) determines a selected adjuster agent 42 and/or ESP agent 41 to handle the opportunity. Also included in agent dispatch system 18 is an agent performance system 28 the tracks, manages, and collects feedback for agents 38 that have been dispatched to handle a loss.

As noted, agent system interface 20 provides a communication link between the insurance opportunity dispatch system 18 and Apps associated with adjuster agents 40 and ESP agents 41 in a network. Data may for example be transmitted back and forth using any known transmission protocol, e.g., a web-based HTML protocol, SMS, etc. In one embodiment, agents 38 may be required to first register with the agent dispatch system 18 via the agent system interface 20 in order to participate in the network. Registration may for example include providing contact information, location data, device information, references, experience, expertise, creating login and password information, etc. Once registered, agent information may be stored in an adjuster database 32 or ESP database 35.

As noted, data processing engine 19 is responsible for receiving loss information, interfacing with various data sources 30, and generating opportunities for agents 38. A policy holder App interface 21 is provided that provides a communication link with policy holder Apps 37, which can for example receive loss information such as ESP requests 39. Loss information may be received via an electronic form. Also provided is an insurance system interface 22 that provides a communication link with insurance systems 36 (and their legacy data sources) for obtaining policy details, claim information, etc., as needed.

Policy holder app interface 21 may for example utilize a web-based form that the policy holder can fill out and submit. The form collects as much loss information as possible from the policy holder 33, and then relies on a rules engine 23 to further populate the form and/or initiate the dispatch process. For example, the rules engine 23 may ping various data sources 30 to determine policy coverage from a policy holder database 15 (e.g., is there a valid policy in place?), obtain address and contact information of the policy holder, etc. Based on the information entered, the rules engine 23 may present additional queries or information to the policy holder 33 for the dispatch process.

Insurance system interface 22 may for example be implemented with an application programming interface (API) that allows third party insurance systems 36 to exchange data with the agent dispatch system 18. The API specification may for example be implemented with Microsoft APIs, Java APIs, or any other suitable specification. Using the API, insurance systems 36 can automatically or manually submit loss information, claims 34 or ESP requests 39 to the agent dispatch system 18. The insurance system interface 22 may also integrate with existing claims management systems and claim assignment management systems utilized by the insurance systems 36, and be implemented to accept claims in standard industry format, e.g., as provided by ACORD, (Association for Cooperative Operations Research and Development), ISO, IVANS etc. Insurance information, such as insurance company data, submitted claims, policy information, assignment information, etc., may be stored in insurance legacy databases, such as claims database 13.

Alternatively, loss information may be submitted to the agent dispatch system 18 manually via a user interface either by an insurance entity or directly by the policy holder 33.

### Adjuster Dispatch

Once sufficient loss information and/or a claim 34 is submitted either directly or via the insurance system interface 22, an opportunity is generated by the data processing engine 19, and the matching system 24 immediately identifies a set of matching adjuster agents 40 best adapted to adjust the claim 34 based on a matching algorithm. For example, if the claim 34 involves a particular type of loss at determined location, the algorithm will identify adjuster agents 38 having the best set of attributes to adjust the claims, e.g., experience with that type of loss and which are near the determined location. In the case where the loss involves a device in the Internet of Things, the matching algorithm will attempt to identify adjuster agents 38 that have the resources (e.g., program code or access to needed program code) to adjust the particular loss and meet any necessary requirements, e.g., ones that have the appropriate security clearance, are an approved provider, etc.

Once a set of matching adjuster agents 40 are identified, selection system 26 broadcasts the assignment opportunity to the matching adjuster agents 40. The opportunity may for example be broadcast via: SMS text messaging, a cellular network, adjuster Apps 40, the World Wide Web, an open cloud computing interface that supports Infrastructure, Platform and/or Software as a Service, etc. The opportunity may be broadcast sequentially to a list of matching adjuster agents based on a ranking until one accepts the opportunity. Alternatively, the opportunity may be broadcast to a batch of matching adjuster agents at the same time and a selection of those accepting the opportunity can be made.

The adjustment opportunity may include various requirements, such as a required response time and cost parameters, etc. For example, any matching adjuster agents interested in accepting the opportunity may be required to respond back within 10 minutes, arrive at the loss site by a certain time and be willing to perform the claim adjustment for a predetermined payment amount.

Accordingly, any of the matching adjuster agents 40 who receive the broadcast and can meet any requirements can respond indicating a desire to accept the opportunity (or respond declining the opportunity). The response may similarly be communicated via: FTP, SMS text messaging, a cellular network, adjuster Apps, the World Wide Web, an open cloud computing interface that supports Infrastructure, Platform and/or Software as a Service, etc. The response may optionally include information such as an estimated time to arrive at a loss site 44, an estimated time to complete the claim adjustment, a cost to complete, potential issues or conflicts, any relevant knowledge, capabilities or expertise possessed by the adjuster agent, etc.

Once one or more responses are received, the selection system 26 determines a selected adjuster agent 42 to handle the claim 34. Selection may be made on a first received basis, based on a rank determined by the matching algorithm, or any other basis. Once a final selection is determined, an agent assignment is made and is recorded in both the claims database 13 and adjuster database 32 assigning the claim 34 (or potential claim) to the selected adjuster agent 42 who then is tasked with adjusting the claim 34.

Once a selected adjuster agent 42 is determined and assigned to the claim 34, agent tracking system 28 may be implemented to monitor and track the performance of the claim adjustment and generate any necessary reports and information, e.g., status messages can be generated back to the insurance system 36, back to the policy holder 33, back to the selected adjuster agent 42, etc. For example, the policy holder 33 may be notified via a text message of an identity and expected arrival time of the selected adjuster agent 42. The insurance system 36 may be notified of the adjustment progress, e.g., when did the selected adjuster agent 42 arrive at the loss site 44, was the adjustment completed, etc. In addition, feedback may be collected from any or all of the parties, e.g., the policy holder 33 may provide feedback regarding the selected adjuster agent 42; the selected adjuster agent 42 may provide feedback regarding the claim 34, policy holder 33, loss site 44 or insurance company; the insurance system 36 may provide feedback regarding the timeliness and accuracy of the selected adjuster agent 42. Feedback information for a claim 34 may be stored in the insurance database 30, adjuster database 32 and/or be provided to the associated insurance system 36.

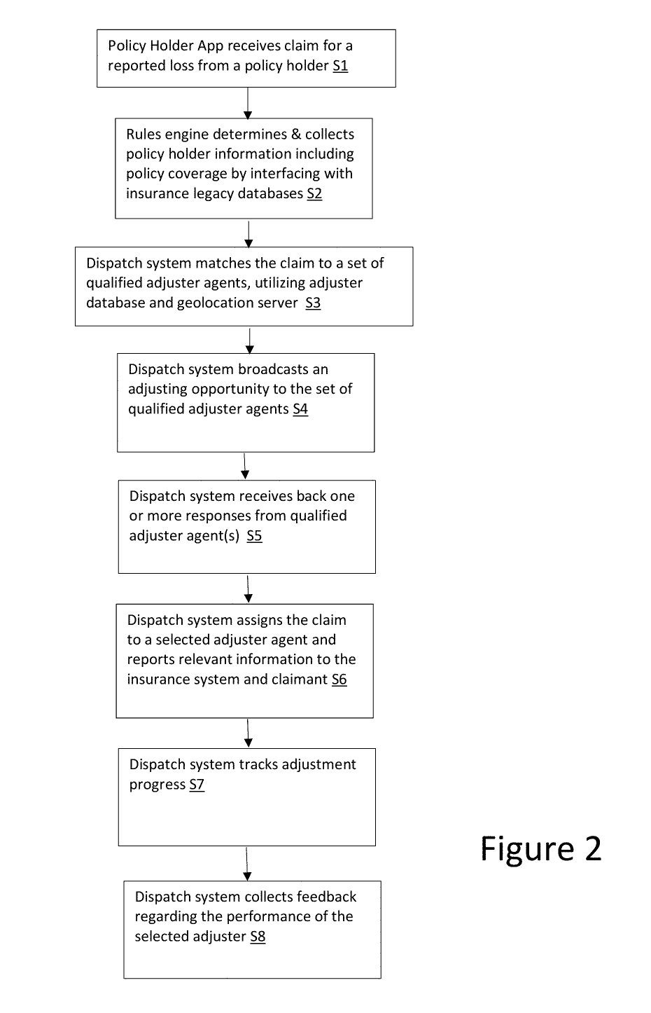

FIG. 2 depicts a flow diagram of an illustrative process for implementing the insurance opportunity dispatch system 18 of FIG. 1 when an adjuster agent is required. At S1, a policy holder 33 for a participating insurance system 36 enters loss and/or claim information into the policy holder app for a reported loss. At S2, the rules engine determines and collects policy holder information including policy coverage type and form (e.g., wind only, HO3, OP3, etc.) by interfacing with insurance legacy databases. This may also include submitting the claim 34 to the participating insurance system 36. Next, the agent dispatch system 18 matches the claim to a set of matching adjuster agents at S3. For example, the claim 34 may be matched based on location, resources, expertise, timing, cost, preference, etc. Once a matching set of adjuster agents are determined, the adjusting opportunity is broadcast to the set of matching adjuster agents at S4 and at S5 one or more responses are received back. At S6, the agent dispatch system 18 assigns the claim to a selected adjuster agent 42 based on a predetermined criteria and reports back the relevant information to the insurance system 36, policy holder 33, etc. Next at S7 the agent dispatch system 18 tracks the adjustment progress, e.g., by entries made into an adjuster App, based on a location of the adjuster agent, based on inquiries from the policy holder 33, etc. Once complete, the insurance opportunity dispatch system 18 collects performance feedback at S8, which is stored and can be used for future adjuster agent selections.

### ESP Dispatch

Similarly, when an ESP request 39 is entered, either directly from the policy holder 33 (e.g., via the policy holder App 37) or from a respective insurance system 36, an ESP opportunity is generated by the data processing engine 19, and matching system 24 identifies a set of matching ESP agents 41 capable of handling the emergency situation (e.g., flood, fire, accident, etc.). Selection system 26 broadcasts the opportunity to the set of matching ESP agents, and a selection is made based on predefined criteria, e.g., which agent responds first, which agent is closest, which agent has the most experience, best rating, etc. Once selected, the opportunity is assigned to the selected ESP agent 43 and the agent tracking system 28 tracks the progress of the ESP agent.

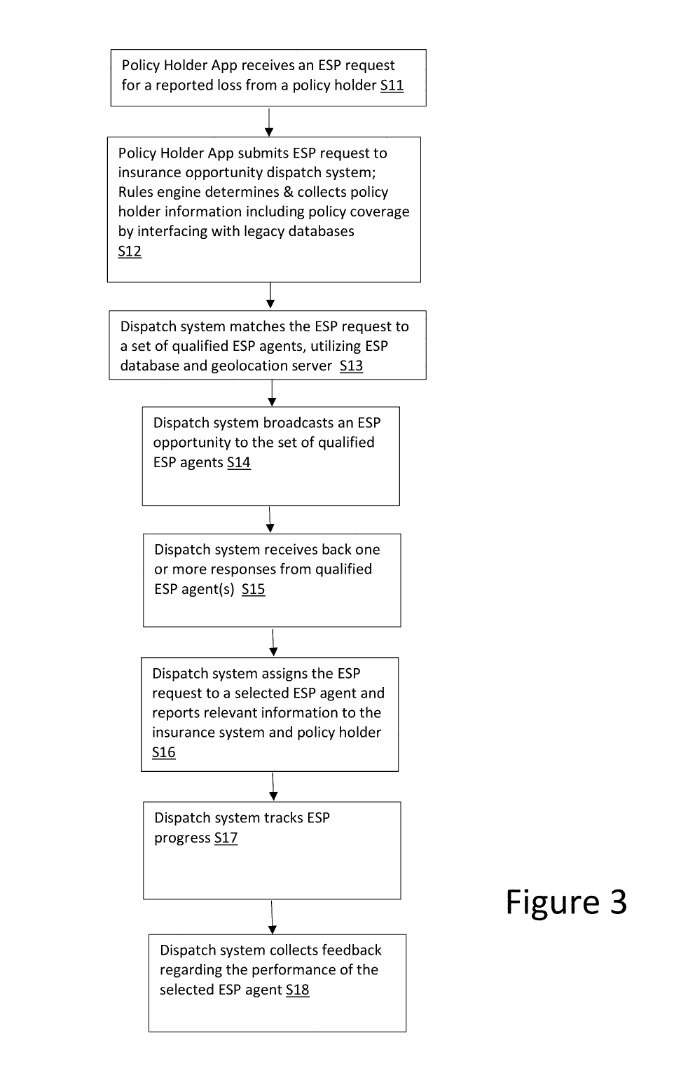

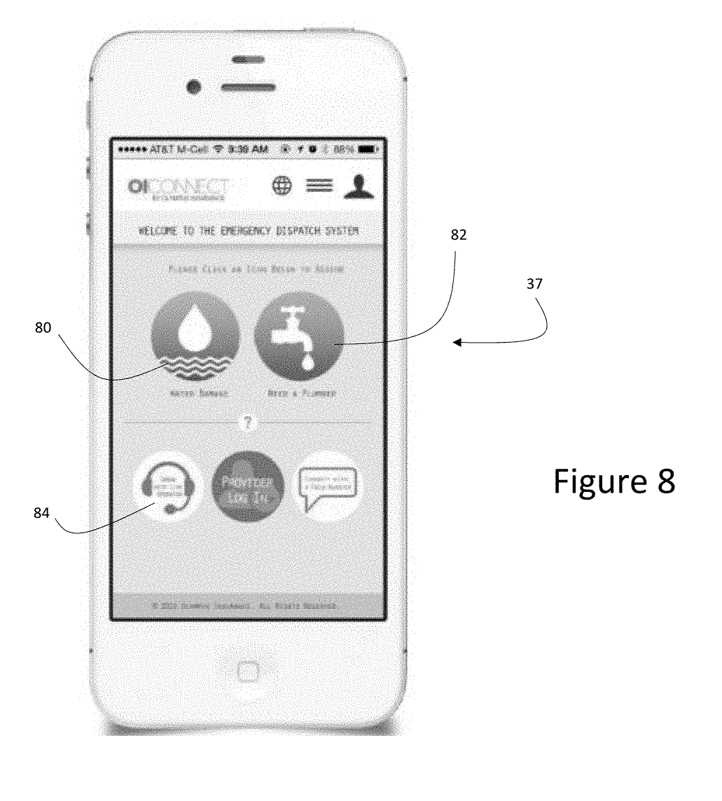

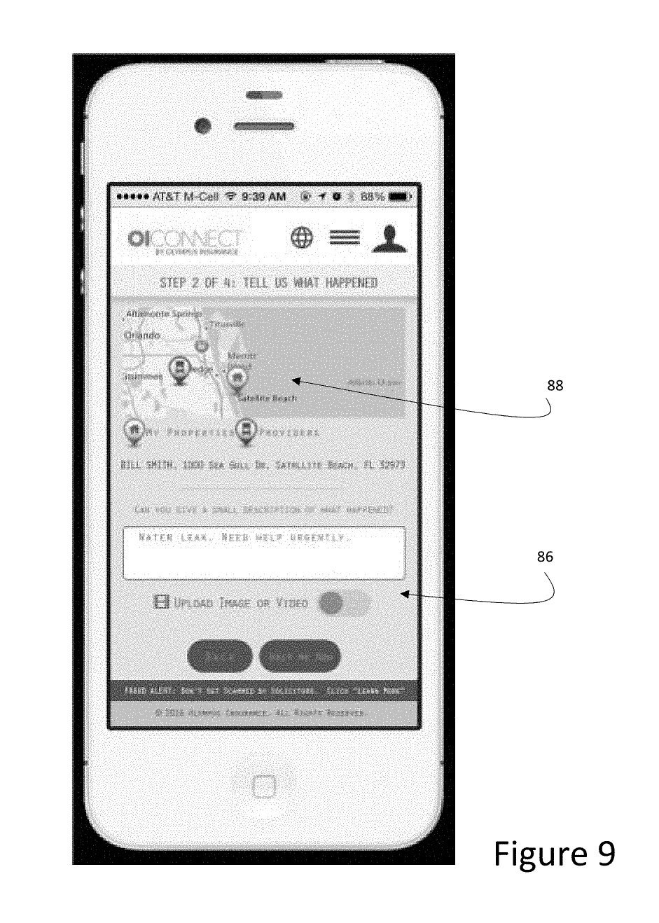

FIG. 3 depicts a flow diagram of an illustrative process for implementing the insurance opportunity dispatch system 18 of FIG. 1 when an ESP agent 41 is required. At S11, a policy holder App 37 receives an ESP request 39 for a reported loss from a policy holder 33 and at S12, the policy holder App 37 submits the ESP request to the agent dispatch system 18. For example, FIG. 8 depicts an interface in a policy holder App 37 that allows the policy holder 33 to report an emergency water damage situation 80, request a plumber 82 or directly speak with an insurance representative 84. From that point, loss information about the policy holder 33 can be collected by the rules engine, including the address of the loss either based on stored information, coverage information, information derived from a location service such as GPS, phone number, or entered information. The policy holder App 37 may also attempt to retrieve policy information at this point from the insurance entity. Information about the loss can also be uploaded, e.g., via text, pictures, video, etc., and the location of the loss and any nearby providers can be displayed, as shown in FIG. 9.

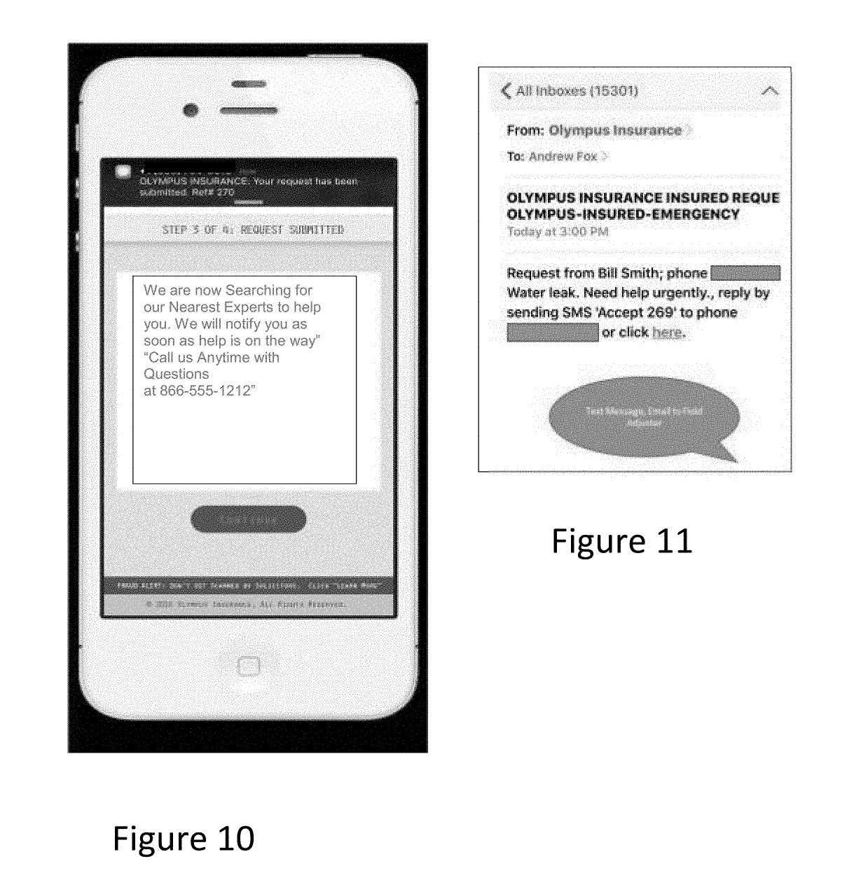

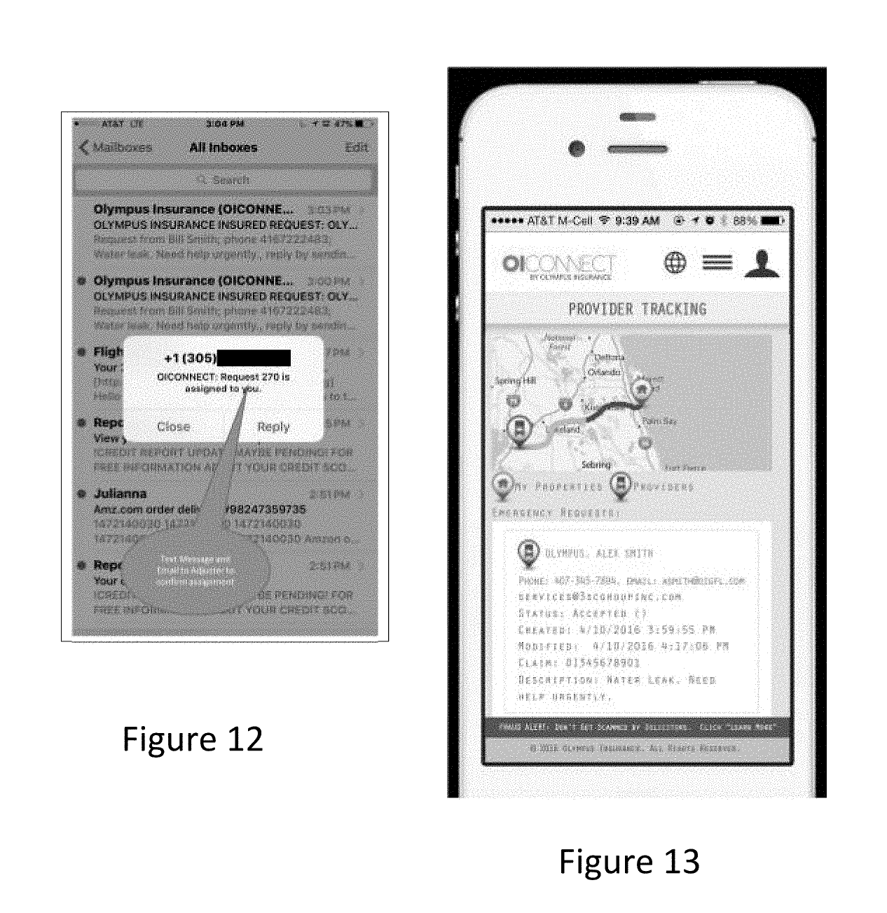

Next, the agent dispatch system 18 matches the ESP request 39 to a set of qualified ESP agents at S13 and reports the process back to the policy holder App 37 as shown in FIG. 10. For example, the ESP request may be matched based on location, resources, expertise, timing, etc. Once a matching set of ESP agents 41 are determined, the ESP opportunity is broadcast to the set of qualified ESP agents 41 at S14 as shown in FIG. 11 and at S15 one or more responses are received back. At S16, the agent dispatch system 18 assigns the ESP opportunity to a selected ESP agent 43 based on a predetermined criteria and reports back the relevant information to the insurance system 36, policy holder 33, etc. This may be done via a text message as shown in FIG. 12. Next at S17 the insurance opportunity dispatch system 18 tracks the ESP progress, e.g., by entries made into an App, based on a located of the ESP agent, based on inquiries from the policy holder 33, etc. This information may be reported back to the policy holder App 37 as shown in FIG. 13, e.g., in the form of a map. Once complete, the insurance opportunity dispatch system 18 collects performance feedback at S18, which is stored and can be used for future ESP agent selections, as well as cost calculators (e.g., labor hours based on time at the loss site), and actuarial loss estimating and rate making.

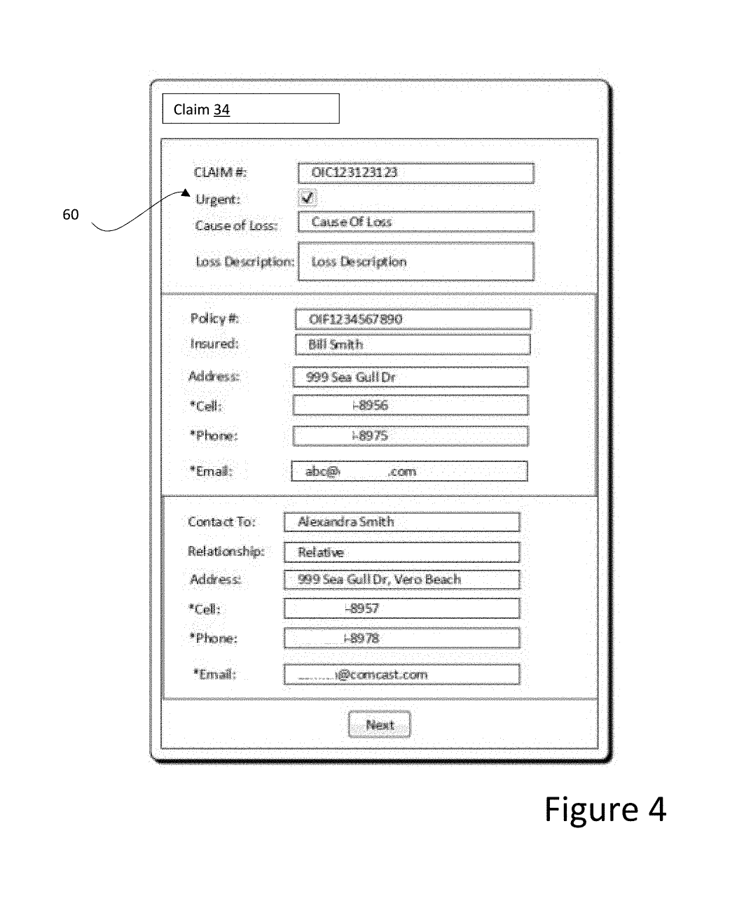

FIG. 4 depicts an example of an interface for capturing, storing and displaying a claim 34, which includes various claim information such as claim number, cause and description, policy information, insured (claimant) information, and contact information. Also included is a priority indicator 60 which in this case determines if the claim is “urgent” or not. Other embodiments may include multiple levels of priority for a claim, e.g., low, medium, high.

Once the claim 34 is captured by the adjuster dispatch system 18, it can be transformed into an adjustment opportunity. The adjustment opportunity may for example be stored in an XML file that includes all of the information in the claim 34, as well as any requirements such as a location radius around the loss site, cost parameters, expertise requirements, etc.

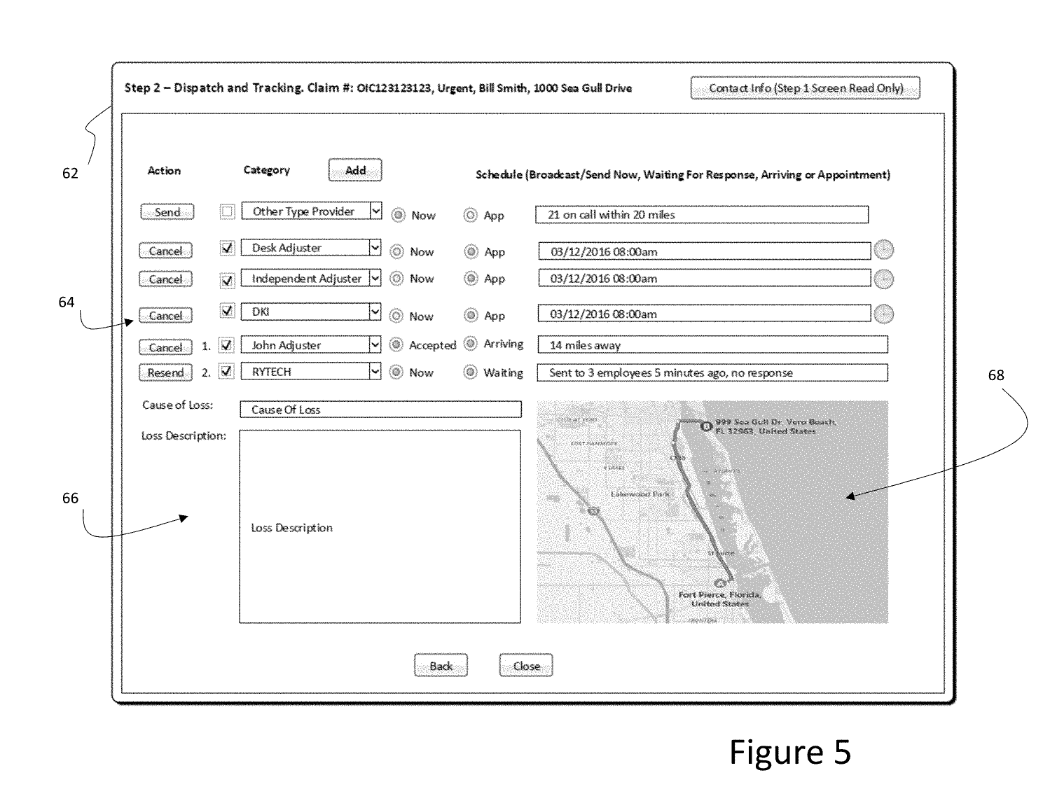

FIG. 5 depicts an illustrative dispatch and tracking dashboard 62 that details a set of matching adjuster agents 64, including action, category and schedule data. In this case, “John Adjuster” accepted the adjuster opportunity and is 14 miles away. The dashboard 62 allows the selection process to be implemented manually and/or viewed by an administrator associated with the adjuster dispatch system 18. Also shown in the dashboard 62 is the associated loss information 66 and a map 68 of the loss site and location of a selected adjuster agent.

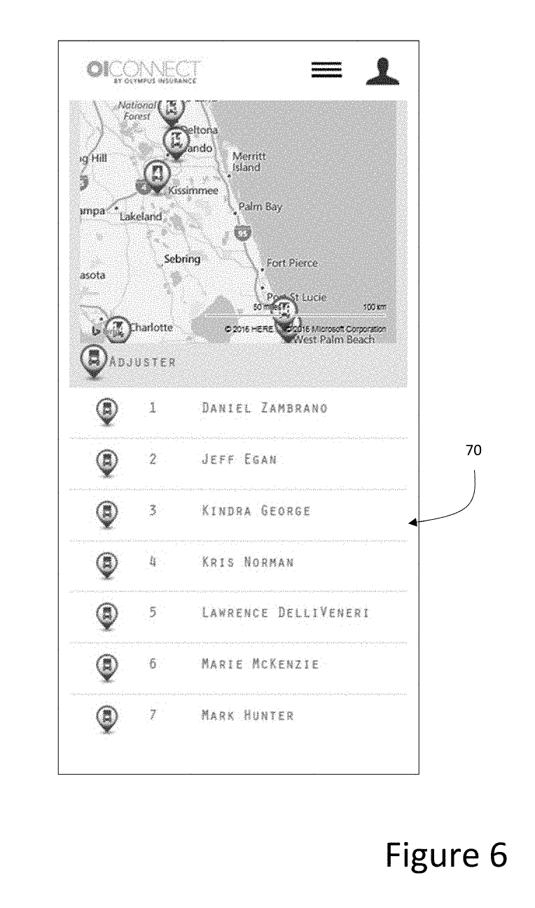

FIG. 6 depicts a further dashboard interface that shows a set of adjuster agents 70 that were identified by a matching algorithm for a received claim. Each of the matched adjuster agents are also depicted on a map to show proximity to a loss site.

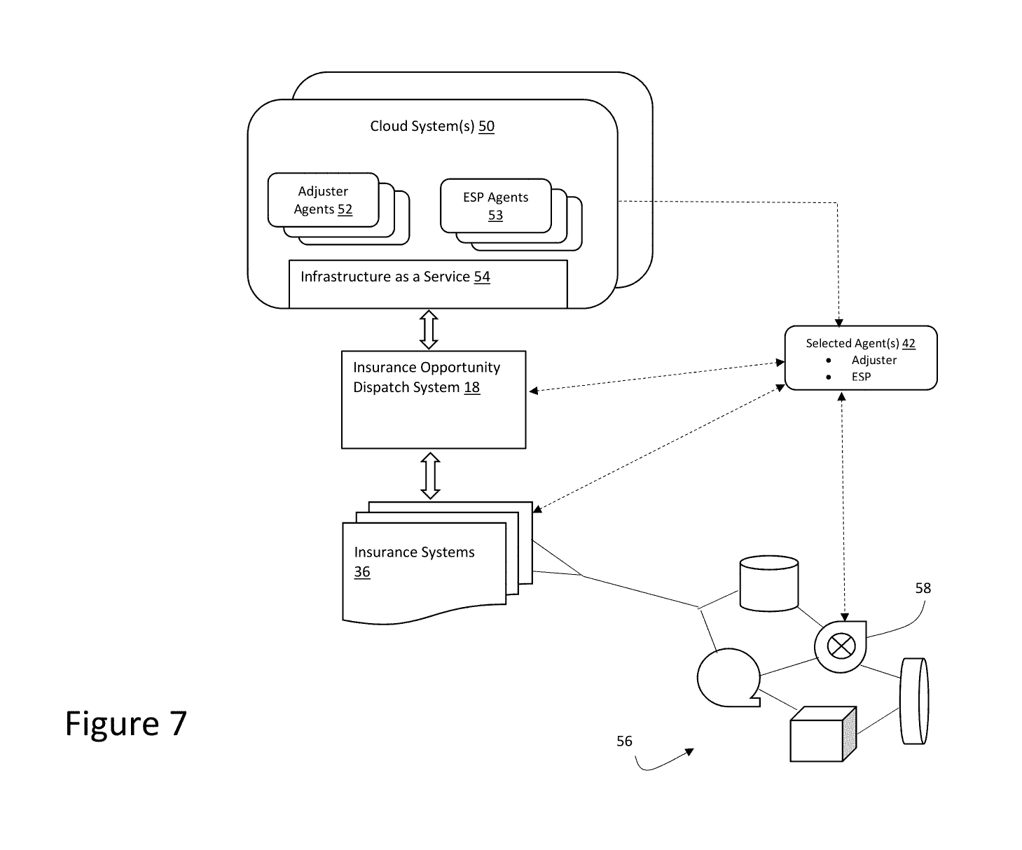

FIG. 7 depicts an illustrative embodiment of insurance opportunity dispatch system 18 being used within the context of the Internet of Things 56. The Internet of Things (IoT) 56 is a network of physical objects, e.g., devices, vehicles, buildings, products, etc., embedded with electronics, software, sensors, and network connectivity that enables these objects to collect and exchange data and processes. The IoT 56 allows objects to be sensed, interrogated and controlled locally via software agents and processes or remotely across an existing network infrastructure, allowing for direct integration of the physical status of each object.

In this example, objects in the IoT 56 may be insured, or have components that are insured by one or more insurance systems 36. For example, a smart building may have insurance to cover damage resulting from a storm and include sensors, cameras, and other equipment to detect damage, such as flooding, equipment failure, etc.; an autonomous automobile may have insurance to cover accidents; a smart appliance may have warranty coverage to insure against product failure; a power turbine may have insurance to cover failure, etc. If a problem is detected at an IoT object 58, the object 58 may include a program to record the loss (e.g., via video data, sensor data, etc.), programmatically submit a claim to an associated insurance system 36, and/or request an emergency service provider (ESP) agent to address an emergency situation.

The insurance system 36 then in turn processes and forwards the claim or ESP request to the insurance opportunity dispatch system 18 to dispatch one or more selected agents 42 to adjust the claim and/or respond to an emergency. For example, in the case where an adjuster agent is required, a selected agent 42 is selected from a set of available adjuster agents 52 in one or more cloud systems 50. Insurance opportunity dispatch system 18 may for example interface with the cloud system(s) 50 using an Infrastructure as a Service (IaaS) 52 interface. In particular, insurance opportunity dispatch system 18 can broadcast to and evaluate different adjuster agents 52 available through the cloud system(s) 50 based on the type of claim, past performances, preferences, etc. For example, if the reported claim involved a smart building that was flooded, a set of adjuster agents 52 having the necessary resources (i.e., programs) to interface with a smart building and interrogate its condition can be identified by specifying (i.e., broadcasting) search criteria to one or more cloud systems 50. Once a set of potential adjuster agents are identified as capable of handling the adjustment, agent dispatch system 18 can determine a selected adjuster agent 42 to adjust the claim, e.g., based on preferences, cost, past performance, etc. The selected adjuster agent 42 may be dispatched to the object 58 over a network and be installed at the site on an internal computing system to interrogate the object 58. For example, sensors can be checked, image data can be evaluated, systems can be tested, reports can be analyzed, questions can be generated, etc. Alternatively, the interrogation process may be done remotely by sending and receiving data. Based on the interrogation, the selected adjuster agent 42 can report back to one or both of the insurance system 36 or agent dispatch system 18.

In the case where an emergency situation is reported, an ESP agent can be selected from a set of ESP agents 53 in one or more cloud systems 50. For example, if a critical part on a large machine failed and caused the machine to overheat, an ESP agent can be dispatched to shut down various systems, engage a fire sprinkler, order replacement parts, etc.

It is understood that agent dispatch system 18 may be implemented as a computer program product stored on a computer readable storage medium. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Python, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Computing system 10 that may comprise any type of computing device and for example includes at least one processor 12, memory 16, an input/output (I/O) 14 (e.g., one or more I/O interfaces and/or devices), and a communications pathway 17. In general, processor(s) 12 execute program code which is at least partially fixed in memory 16. While executing program code, processor(s) 12 can process data, which can result in reading and/or writing transformed data from/to memory and/or I/O 14 for further processing. The pathway 17 provides a communications link between each of the components in computing system 10. I/O 14 can comprise one or more human I/O devices, which enable a user to interact with computing system 10. Computing system 10 may also be implemented in a distributed manner such that different components reside in different physical locations.

Furthermore, it is understood that the ERVGS 18 or relevant components thereof (such as an API component, agents, etc.) may also be automatically or semi-automatically deployed into a computer system by sending the components to a central server or a group of central servers. The components are then downloaded into a target computer that will execute the components. The components are then either detached to a directory or loaded into a directory that executes a program that detaches the components into a directory. Another alternative is to send the components directly to a directory on a client computer hard drive. When there are proxy servers, the process will select the proxy server code, determine on which computers to place the proxy servers' code, transmit the proxy server code, then install the proxy server code on the proxy computer. The components will be transmitted to the proxy server and then it will be stored on the proxy server.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. An agent dispatch system, comprising:
a data processing engine that inputs loss information, interfaces with third party data sources to obtain policy details, and creates at least one of an adjuster assignment opportunity or an emergency service provider (ESP) claim assignment opportunity;
an agent system interface that provides a communication link and maintains information for a network of agents;
a matching system that identifies a set of matching agents from the network of agents;
a selection system that broadcasts an opportunity comprising at least one of the adjuster assignment opportunity and ESP claim assignment opportunity to the set of matching agents, processes responses from the set of matching agents, and assigns the opportunity to a selected agent; and
an agent performance system that tracks and monitors performance of the selected agent, and collects feedback regarding the selected agent.

2. The agent dispatch system of claim 1, wherein the data processing engine includes an application programming interface (API) that integrates with third party insurance claim management systems.

3. The agent dispatch system of claim 1, wherein the opportunity is broadcast over a network that utilizes at least one of: a text message, an email, or a mobile application.

4. The agent dispatch system of claim 1, wherein the network of agents comprise software agents.

5. The agent dispatch system of claim 1, wherein the matching system includes an algorithm that ranks the set of agents based on proximity to a location of a type of loss associated with the opportunity.

6. The agent dispatch system of claim 5, wherein the algorithm further ranks the set of agents based on at least one of: cost, experience, prior feedback, or expertise.

7. The agent dispatch system of claim 1, wherein the opportunity includes an associated priority level.

8. The agent dispatch system of claim 1, wherein the data processing engine includes an application programming interface (API) that interfaces with a third party claims assignment management system.

9. A computer program product stored on a computer readable storage medium, which when executed by a computing system, provides agent dispatching, comprising:
program code for receiving loss information and creating an opportunity including at least one of an adjuster assignment opportunity or an emergency service provider (ESP) claims assignment opportunity;
program code that provides a communication link and maintains information for a network of agents;
program code that identifies a set of matching agents from the network of agents to handle the opportunity;
program code that broadcasts the opportunity to the set of matching agents, analyzes responses from the set of matching agents, and assigns the opportunity to a selected agent; and
program code that monitors performance of the selected agent.

10. The computer program product of claim 9, further comprising an application programming interface (API) that integrates with third party claim management systems.

11. The computer program product of claim 9, wherein the opportunity is broadcast over a network that utilizes at least one of: a text message, an email, or a mobile application.

12. The computer program product of claim 9, wherein the network of agents comprise software agents.

13. The computer program product of claim 9, further comprising an algorithm that ranks the set of agents based on proximity to a site of a loss associated with a claim.

14. The computer program product of claim 13, wherein the algorithm further ranks the set of agents based on at least one of: cost, experience, prior feedback, or expertise.

15. The computer program product of claim 9, wherein the opportunity includes an associated priority level.

16. The computer program product of claim 9, further comprising an application programming interface (API) that integrates with a third party claims assignment management system.

17. A computerized method that provides insurance opportunity dispatching, comprising:
inputting an electronic form that details information about a loss;
interfacing with a third party data source to obtain policy details associated with the loss;
creating an opportunity that includes at least one of an adjuster assignment opportunity or an emergency service provider (ESP) claims assignment opportunity;
identifying a set of matching agents from a network of agents to handle the opportunity;
broadcasting the opportunity to the set of matching agents, analyzing responses from the set of matching agents, and assigning the opportunity to a selected agent; and
monitoring performance of the selected agent.

18. The computerized method of claim 17, further comprising providing an application programming interface (API) that integrates with the third party data source, wherein the third party data source includes a claims management system.

19. The computerized method of claim 17, wherein the opportunity is broadcast over a network that utilizes at least one of: a text message, an email, or a mobile application.

20. The computerized method of claim 17, wherein the network of agents comprise software agents.

21. The computerized method of claim 17, further comprising using an algorithm to rank the set of matching agents based on proximity to a site of a loss associated with a claim.

22. The computerized method of claim 21, wherein the algorithm further ranks the set of matching agents based on at least one of: cost, experience, prior feedback, or expertise.

23. The computerized method of claim 17, further comprising providing an application programming interface (API) that integrates with a third party claim assignment management system.
